(19) United States
(12) Patent Application Publication
(10) Pub. No.: US 2026/0218535 A1
(43) Pub. Date: Jul. 30, 2026

(54) Inflatable Booth for Automobile Cleaning, Upkeep, and Maintenance

(71) Applicant: Thomas Williams, Montgomery, TX (US)

(72) Inventor: Thomas Williams, Montgomery, TX (US)

(21) Appl. No.: 19/454,564

(22) Filed: Jan. 21, 2026

Related U.S. Application Data
(60) Provisional application No. 63/750,504, filed on Jan. 28, 2025.

(51) Int. Cl. E04H 15/20; E04H 6/04

(52) U.S. Cl. CPC E04H 15/20; E04H 6/04; E04H 2015/201

(57) ABSTRACT

An inflatable booth designed to provide an enclosed environment in which a person can wash, detail, and/or wrap their automobile. The booth may also be used for such activities as applying window tint or performing maintenance work. The booth is inflatable, making it easily transportable, and is illuminated by removable lights. The booth has translucent / transparent windows which allow the lights to shine through and reflective material which helps disperse the light.

### CROSS REFERENCE TO RELATED APPLICATION

This application claims priority to U.S. Application No. 63/750,504 filed on January 28, 2025, the disclosure of which is incorporated herein by reference for all purposes.

### FIELD OF THE INVENTION

The present invention relates to an inflatable booth and, more particularly, to an inflatable booth for use in cleaning, detailing, or otherwise working on an automobile.

### BACKGROUND OF THE INVENTION

Inflatable booths and tunnels have been used for a multitude of purposes. US Patent 9,878,342 and US Patent 10,766,049, both of which are incorporated herein by reference for all purpose disclose inflatable drive in booths for applying paint to an automobile. US Patent 10,717,103, incorporated herein by reference for all purposes, discloses an inflatable booth used for spraying bed liner into a truck bed. US Patent 11,560,730, incorporated herein by reference for all purposes, discloses an inflatable booth used in detecting dents in the body of an automobile. Each of these prior art inflatable booths allows for an automobile to be driven partially or completely through an inflatable structure.

### SUMMARY OF THEINVENTION

The booth of the present invention is designed to provide an enclosed environment in which a person can wash, detail, and/or wrap their automobile. The booth may also be used for such activities as applying window tint or performing maintenance work. The booth is inflatable, making it easily transportable, and is illuminated by removable lights.

### BRIEF DESCRIPTION OF THE DRAWINGS

FIG. 1 is a perspective view of one embodiment of the booth of the present invention.

FIG. 2 is another perspective view of the embodiment shown in FIG. 1.

FIG. 3 is a rear view of the embodiment shown in FIG. 1.

FIG. 4 is another rear view of the embodiment shown in FIG. 1.

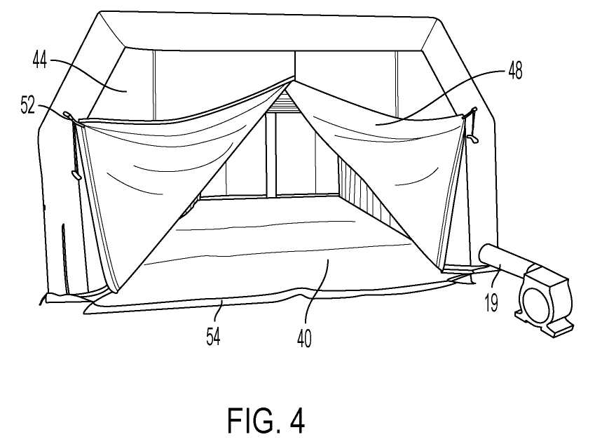

FIG. 5 is an interior view of the embodiment shown in FIG. 1.

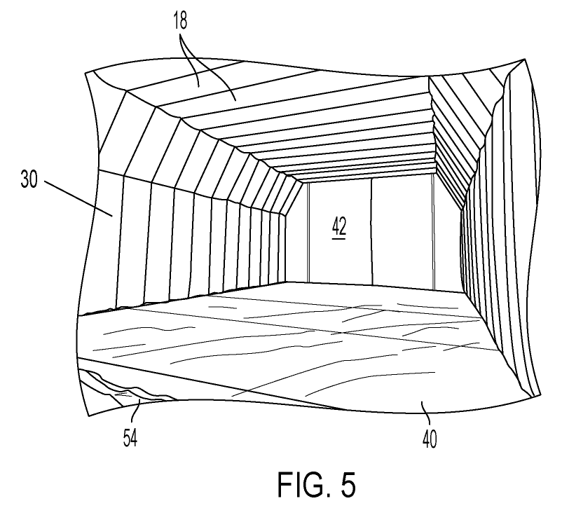

FIG. 6 depicts the general shape of the inflatable booth and the outer and inner walls thereof.

FIGS. 7A - 7C depict the illumination portions of the booth of the present invention.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements which perform the same functions across various embodiments. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

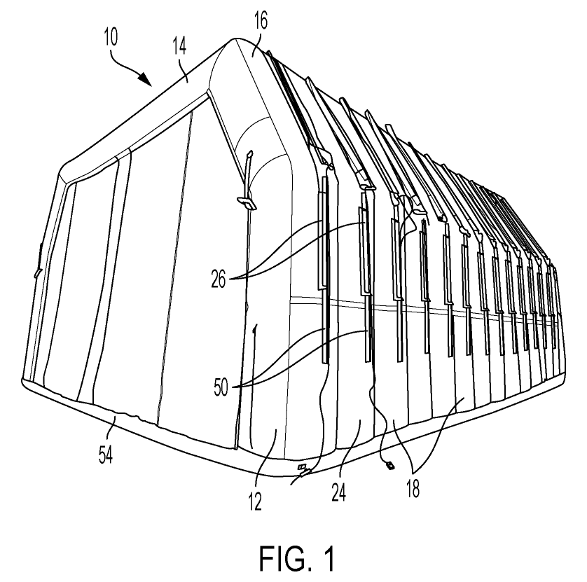

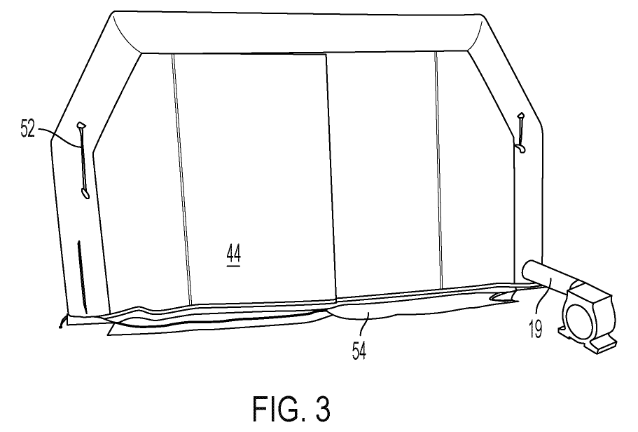

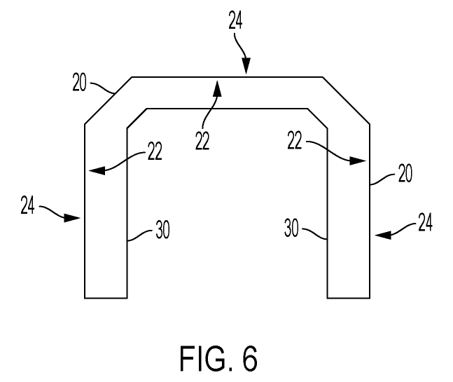

Turning to FIG. 1 there is shown, generally as 10, one embodiment of the inflatable booth of the present invention. Inflatable booth 10 forms an archway or tunnel, having walls 12, a ceiling 14, and angled corners 16. Inflatable booth 10 should be large enough for an automobile to drive into it, and leave room for one or more persons to work on the automobile inside the booth. The shape of booth 10 is achieved by a series of connected inflatable tubes 18. Tubes 18 are connected in such a way that air can flow between them. Accordingly, booth 10 can be fully inflated from a single inflation port 19 (see FIG. 3), though more than one port may be desired to increase inflation speed. The tubes 18 connected together form the archway. The tubes being inflatable thus means that the tunnel of booth 10 has an outer wall 20 and an inner wall 30 with air in between (see FIG. 6).

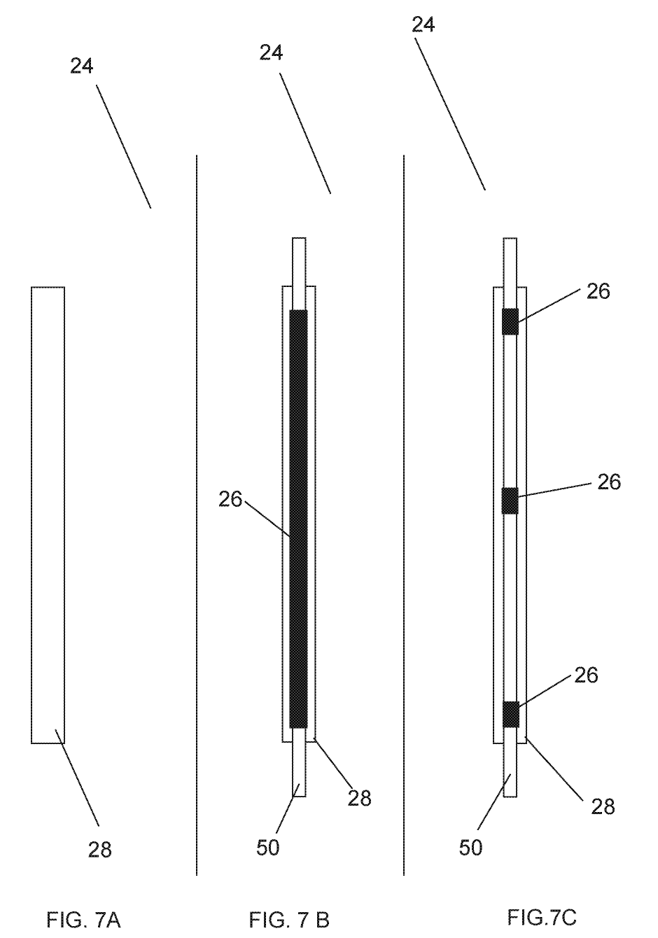

As best seen in FIGS. 1 and 7, there are rectangular windows 28 in the outer wall 20 which are formed of transparent or translucent material. Mounts 26 are positioned along the exterior surface 24 of outer wall 20. Mounts 26 are positioned over the windows 28. A plurality of light sources 50 are removably held in mounts 26. The light from light sources 50 shines through windows 28 into booth 10. Windows 28 may be in some or all of tubes 18 and may be along the vertical walls 12 and/or the angled sections 16. It will be appreciated that light sources 50 can be held in place by various means, including but not limited to, straps which are affixed to outer wall 20 and which wrap around light sources 50, pockets, pouches, or sleeves along outer wall 20 in which light sources 50 can rest, hook-and-loop fabric affixed to the light sources 50 and to outer wall 20.

FIG. 7 depicts a few versions the windows 28, mounts 26 ,and light sources 50. FIG. 7A simply shows one of the windows 28 without any mount or light source. FIG. 7B shows mount 26 in the form of a long sleeve or pocket in which light source 50 slides. It will be appreciated that the pocket does not go all the way around the light as then it would prevent the light from shining through window 28. It will also be appreciated that in this version, the pocket is tight enough to hold the light source 50 in place, but still allows it to be removed with minimal effort. Thus, the material may be somewhat elastic. FIG. 7C shows mount 26 as a plurality of straps around light source 50. It will be appreciated that mounts 26 can be in various forms so long as they hold light source 50 in position over window 28, such that light source 50 can shine light through window 28, and allow for light source 50 to be removed.

It is preferred that light sources 50 are removable so booth 10 can be deflated and stored when not in use. Light sources 50 can be fluorescent lights, light emitting diode (LED) lights, which may be LED tube lights, flexible lights (strips, tapes, or ropes), or other lights which are easily attached to and removed from booth 10. In a preferred embodiment, light sources 50 are flexible lights. Power cords, straps, pouches, and the like may not be seen in the figures but would be well understood by those of skill in the art.

In a preferred embodiment, the interior face 22 of outer wall 20 (see FIG. 6) is formed from, or coated with a reflective material (except for windows 28). The reflective material of the inner face 22 of outer wall 20 helps disperse the light throughout the interior of booth 10. Inner wall 30 of booth 10 may be made of a transparent or translucent material. In a preferred embodiment, the inner wall 30 is made of a translucent white material.

In another embodiment, outer wall 20 is wholly made of a translucent or transparent material. In such a case, instead of illuminating the booth with light sources 50, the booth may be illuminated using sunlight, ambient light within a larger structure, or other external sources of light. The light sources 50 may also be used with the translucent or transparent cover if desired.

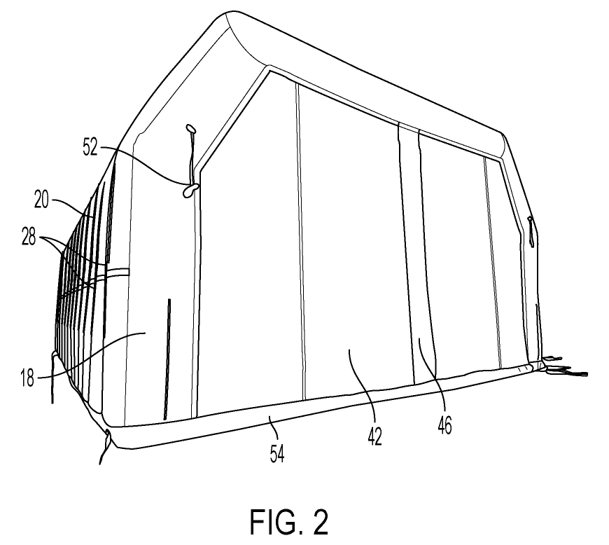

In a preferred embodiment, inflatable booth 10 includes a non-inflatable floor 40, and non-inflatable end walls 42 and 44. As seen in FIGS. 2 and 3, end walls 42 and 44 may be removably affixed by hook-and-loop fabric. End walls 42 and 44 may also include slits 46 and 48, respectively, which allow the end wall to be opened to allow for the passage of automobiles and people. Straps 52 positioned on booth 10 may be used to hold end walls 42 and 44 open if needed.

Floor 40 preferably includes lip 54 which extends outside of the booth 10. Lip 54 is designed to hold an optional foam insert (not shown) generally in the form of a foam cylinder or a foam tube. The foam insert is rolled up in lip 54. Hook-and-loop fabric along lip 54 can be used to maintain the rolled shape. FIG. 3 shows lip 54 unrolled. FIGS. 1 and 2 show lip 54 rolled around a foam insert. Floor 40 preferably has a lip 54 at both end walls 42 and 44. The foam insert thus creates a raised rim along the open ends of the booth to prevent water, paint, sprays, debris, or the like from leaving the booth. The foam insert being removable allows one to drive a vehicle into and out of the booth without crushing the foam insert.

To use the booth 10, an automobile is driven into the booth 10. If needed, a foam insert is wrapped up and secured in lips 54. The light sources 50 are illuminated. The user can then wash the automobile, detail the automobile, apply paint wrap, or other activities as desired. If the user is washing the automobile, the foam inserts help prevent the leakage of water outside the booth. This ensures that the booth can be used in locations in which it is not desirable to dump large amounts of water. The water can be vacuumed, or pumped out of booth 10 as needed.

Booth 10 can be made of materials suitable for inflating. The materials must be durable enough to withstand the air pressure of inflation and to support the light sources 50 mounted on outer wall 20. For example, booth 10 can be made of durable sheet material such as plastic or fabric, including but not limited to vinyl, polyethylene, polyvinyl chloride, or oxford nylon. In a preferred embodiment, the booth is made of a vinyl material. End walls 42 and 44, and floor 40 can be made of the same material. The floor 40 may be a separate piece of material or may be permanently formed with the inflatable tunnel.

Because booth 10 is inflatable, it can easily be installed and taken down at various locations. If needed, ropes can be used to anchor the booth down in a windy area. The easy installation and take down of the booth, as well as its portability when deflated allows for more flexibility when working on automobile. The booth can be brought to the automobile, rather than the other way around. Prior art booths which are not inflatable and which employ complex lighting mechanics cannot be readily taken down and moved.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

1. An inflatable booth for performing services on an automobile, comprising:
an inflatable tunnel having first and second open ends and having inner and outer walls which form sides and a ceiling;
at least a portion of said outer wall being a window formed from translucent or transparent material;
at least one light source removably mounted on said outer wall over said window such that it is operative to shine light through said window;
an inner surface of said outer wall being formed of or coated with a reflective material.

2. The inflatable booth of claim 1, further comprising at least one non- inflatable end wall mounted at an end of said tunnel.

3. The inflatable booth of claim 2, further comprising a non-inflatable floor.

4. The floor of claim 3, further comprising a lip which extends outside of said tunnel and which is rollable around a removable insert and thereby create a raised rim at an end of said tunnel.

5. The floor of claim 3, having a pair of lips, one of each extending outside of each end of said tunnel, each lip being rollable around a removable insert to thereby create raised rims at each end of said tunnel.

6. The inflatable booth of claim 1, wherein there are a plurality of windows in said outer wall, each of said windows being formed from a translucent or transparent material.

7. The inflatable booth of claim 6, wherein there are a plurality of light sources each removably mounted over respective windows.

8. The inflatable booth of claim 1, wherein said inner wall is formed of a translucent or transparent material.

9. The inflatable booth of claim 1, wherein said light source is a fluorescent light, a light emitting diode light.

10. The inflatable booth of claim 1, wherein the booth is made of materials comprising vinyl, polyethylene, polyvinyl chloride, or oxford nylon.
